(19) United States
(12) Patent Application Publication
(10) Pub. No.: US 2004/0229072 A1
(43) Pub. Date: Nov. 18, 2004

(54) Nickel base superalloy

(76) Inventor: Kenneth S. Murphy, Norton Shores, MI (US)

Correspondence Address: ECKERT SEAMANS CHERIN & MELLOTTT, LLC, ALCOA TECHNICAL CENTER,, 100 TECHNICAL CENTER DRIVE, ALCOA CENTER, PA, 15069-0001, US

(21) Appl. No.: 10/734,078

(22) Filed: Dec. 11, 2003

Related U.S. Application Data
(60) Provisional application No. 60/433,891, filed on Dec. 16, 2002.

(51) Int. Cl. C22C 19/05; B32B 15/04

(52) U.S. Cl. 428/627; 420/443; 420/448; 428/652; 428/680

(57) ABSTRACT

Nickel base superalloy consisting essentially of, in weight %, about 3% to about 12% Cr, up to about 15% Co, up to about 3% Mo, about 3% to about 10% W, up to about 6% Re, about 5% to about 7% Al, up to about 2% Ti, up to about 1% Fe, up to about 2% Nb, about 3% to about 12% Ta, up to about 0.07% C, about 0.030% to about 0.80% Hf, up to about 0.10% Zr, up to about 0.02% B, up to about 0.050% of an element selected from the group consisting of Y and Lanthanide series elements, and balance Ni and incidental impurities with a S concentration preferably of 2 ppm by weight or less. The nickel base superalloy pursuant to the invention possesses improved high temperature oxidation resistance. The nickel base superalloy as a substrate can be coated with an outwardly grown diffusion aluminide bondcoat followed by deposition of a ceramic thermal barrier coating (TBC) on the bondcoat. Spallation of the TBC is significantly prolonged when the bondcoat comprises an outwardly grown, single phase diffusion aluminide bondcoat on the substrate.

This application claims the benefits and priority of provisional application Serial No. 60/433,891 filed Dec. 16, 2002.

### FIELD OF THE INVENTION

The present invention relates to a nickel base superalloy having improved oxidation resistance and useful as a substrate to receive a bondcoat and thermal barrier coating on the bondcoat to improve adherence of the thermal barrier coating.

### BACKGROUND OF THE INVENTION

Superalloys are widely used as castings in the gas turbine engine industry for critical components, such as turbine blades and vanes, subjected to high temperatures and stress levels. Such critical components oftentimes are cast using well known directional solidification (DS) techniques that provide a single crystal or columnar grain microstructure to optimize properties in a particular direction.

Directional solidification casting techniques are well known wherein a nickel base superalloy remelt ingot is vacuum induction remelted in a crucible in a casting furnace and poured into a ceramic investment cluster mold disposed in the furnace having a plurality of mold cavities. During directional solidification, the superalloy melt is subjected to unidirectional heat removal in the mold cavities to produce a columnar grain structure or single crystal in the event a crystal selector or seed crystal is incorporated in the mold cavities. Unidirectional heat removal can be effected by the well known mold withdrawal technique wherein the melt-filled cluster mold on a chill plate is withdrawn from the casting furnace at a controlled rate. Alternately, a power down technique can be employed wherein induction coils disposed about the melt-filled cluster mold on the chill plate are de-energized in controlled sequence. Regardless of the DS casting technique employed, generally unidirectional heat removal is established in the melt in the mold cavities.

Such melting and DS casting processes typically have produced DS nickel base superalloy castings, such as high volume production turbine blade castings, having bulk sulfur impurity concentrations in the range of 2 to 10 parts per million (ppm) by weight. Such sulfur impurity levels have been thought to have an adverse effect on high temperature oxidation resistance of nickel base superalloys in service, especially as engine operating temperatures have increased. U.S. Pat. No. 5,922,148 describes nickel base superalloys having ultra low sulfur concentration to improve oxidation resistance of the superalloy.

Nickel base superalloy castings, such as gas turbine engine blades, are oftentimes coated with a thermal barrier coating system that includes a bondcoat on which a ceramic thermal barrier coating is deposited to protect the superalloy from high temperature oxidation. Thermal barrier coatings can fail in service in a gas turbine engine as a result of spallation of the ceramic thermal barrier coating off of the bondcoated substrate. The oxidation resistance of the superalloy substrate and of the bondcoat are factors that determine the service life of the ceramic thermal barrier coating system. For example, it is desirable to use a nickel base superalloy having superior oxidation resistance for retaining engine performance after the turbine blade tip has experienced a rub with a tip seal, since the rub may remove some or all blade tip coating, exposing the nickel base superalloy substrate to the hot gas turbine environment.

### SUMMARY OF THE INVENTION

The present invention provides a nickel base superalloy consisting essentially of, in weight %, about 3% to about 12% Cr, up to about 15% Co, up to about 3% Mo, about 3% to about 10% W, up to about 6% Re, about 5% to about 7% Al, up to about 2% Ti, up to about 1% Fe, up to about 2% Nb, about 3% to about 12% Ta, up to about 0.07% C, about 0.030% to about 0.80% Hf, up to about 0.10% Zr, up to about 0.02% B, up to about 0.050% of an element selected from the group consisting of Y and Lanthanide Series elements having atomic numbers 58-71, and balance Ni and incidental impurities with a S concentration preferably of 2 ppm by weight or less.

A nickel base superalloy pursuant to the invention possesses improved high temperature oxidation resistance to help retain turbine blade tip dimensions when the tip coating is removed by rubbing against the tip seal, thereby retaining engine performance for a longer time. A nickel base superalloy substrate pursuant to the invention can be coated with an inwardly grown or outwardly grown diffusion aluminide bondcoat followed by deposition of a ceramic thermal barrier coating (TBC) on the bondcoat. Spallation of the TBC is significantly prolonged when the bondcoat comprises an outwardly grown, single phase diffusion aluminide bondcoat and the substrate comprises the superalloy with Hf and with or without Y present as substrate alloying elements.

Other advantages, features, and embodiments of the present invention will become apparent from the following description taken with the following drawings.

### DESCRIPTION OF THE DRAWINGS

FIG. 1 is a graph of weight change versus number of cycles in a cyclic oxidation test for specimens listed in the figure.

FIG. 2 is a graph of weight change versus number of cycles of a cyclic oxidation test for specimens listed in the figure having an outwardly grown, single phase Pt-modified diffusion aluminide MDC-150L bondcoat on some specimens and an inwardly grown, multi-phase Pt-modified diffusion aluminide LDC-2E bondcoat on other specimens.

FIG. 3 is a bar graph showing TBC adherence in a cyclic oxidation test for substrates having the outwardly grown, single phase Pt-modified diffusion aluminide MDC-150L bondcoat on some specimens and the inwardly grown aluminide diffusion LDC-2E bondcoat on other specimens.

FIG. 4 is a bar graph showing TBC adherence in a cyclic oxidation test for substrates having the outwardly grown, single phase Pt-modified diffusion aluminide MDC-150L bondcoat.

FIG. 5 is a bar graph showing TBC adherence in a cyclic oxidation test for substrates having the outwardly grown, single phase Pt-modified diffusion aluminide MDC-150L bondcoat.

### DESCRIPTION OF THE INVENTION

The present invention provides a nickel base superalloy consisting essentially of, in weight %, about 3% to about 12% Cr, up to about 15% Co, up to about 3% Mo, about 3% to about 10% W, up to about 6% Re, about 5% to about 7% Al, up to about 2% Ti, up to about 1% Fe, up to about 2% Nb, about 3% to about 12% Ta, up to about 0.07% C, about 0.030% to about 0.80% Hf, up to about 0.10% Zr, up to about 0.02% B, up to 0.050% of a rare earth element selected from the group consisting of Y and Lanthanide series elements having atomic numbers 58 to 71 (preferably Ce, La and/or Er), and balance Ni and incidental impurities with a S concentration preferably of 2 ppm by weight or less. In a particular embodiment of the invention, a rare earth element selected from the group consisting of Y and Lanthanide series elements having atomic numbers 58 to 71 (preferably Ce, La and/or Er) is included in the alloy in an amount of about 0.0005% to about 0.050 weight %.

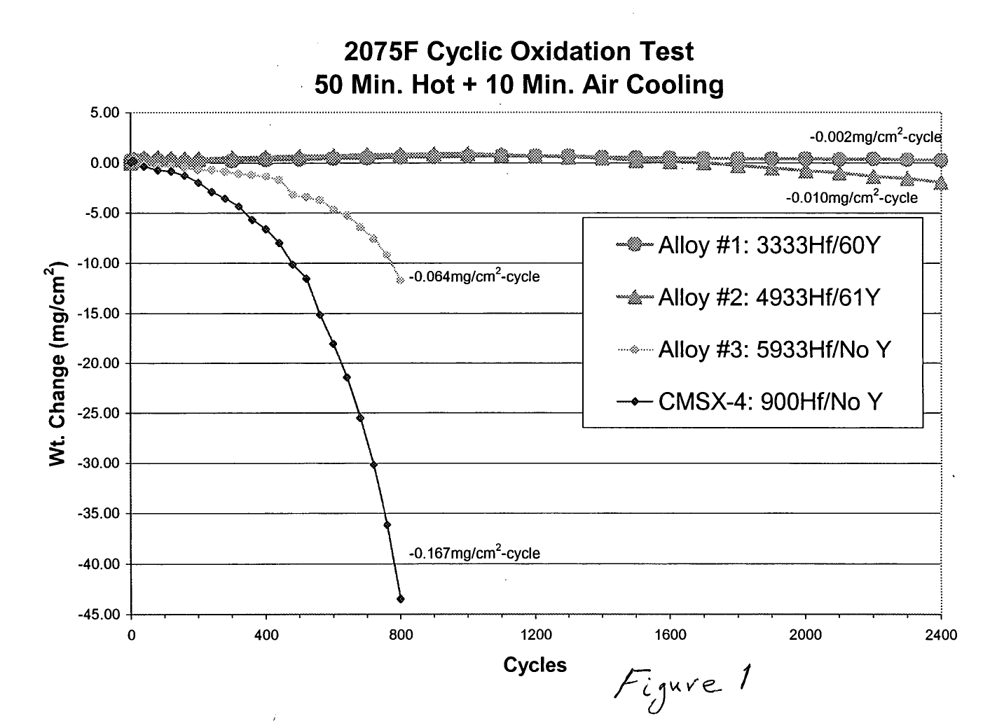

FIG. 1 shows the weight change versus number of cycles in a cyclic oxidation test (Lindberg test) conducted in air at 2075 degrees F where each cycle comprised placing the specimens in a vertically oriented tube furnace for 50 minutes and then removing the specimens from the furnace to cool in air for 10 minutes. A specimen was considered failed in the cyclic oxidation testing when the specimen lost 5 mg/cm² in weight. A comparison of weight loss rates is made to assess the effectiveness of alloy chemistry changes on oxidation resistance. In most cases, a slower weight loss rate is better than a higher weight loss rate.

A comparison baseline nickel base superalloy known as CMSX-4 superalloy described in U.S. Pat. No. 4,643,782 was tested to provide baseline specimens for comparison. The CMSX-4 test alloy comprised a nominal composition as shown in Table 1 below.

Nickel base superalloy test alloys 1, 2, and 3 pursuant to the invention were also cyclic oxidation tested in the same manner. The nominal compositions of the test alloys 1, 2, and 3 (designated Specimens 1, 2, 3) are shown in Table 1 below where ppm is ppm by weight.

TABLE 1
Nominal Chemistries

| | Y | Hf | S | Ti | Al | Cr | Co | Mo | Ni | Re | Ta | W |
|---|---|---|---|---|---|---|---|---|---|---|---|---|
| | (ppm) | (ppm) | (ppm) | (% Wt.) | (% Wt.) | (% Wt.) | (% Wt.) | (% Wt.) | (% Wt.) | (% Wt.) | (% Wt.) | (% Wt.) |
| CMSX-4 | 1.7 | 900 | 2.0 | 1.0 | 5.6 | 6.3 | 9.5 | 0.6 | Bal. | 2.9 | 6.4 | 6.5 |
| Specimen 1 | 60.3 | 3333 | 1.3 | 1.0 | 5.7 | 6.3 | 9.5 | 0.6 | Bal. | 2.9 | 6.4 | 6.4 |
| Specimen 2 | 61.3 | 4933 | 1.0 | 1.0 | 5.5 | 6.3 | 9.6 | 0.6 | Bal. | 3.0 | 6.4 | 6.5 |
| Specimen 3 | 1.0 | 5933 | 2.0 | 1.0 | 5.8 | 6.3 | 9.6 | 0.5 | Bal. | 2.9 | 6.4 | 6.4 |

CMSX-4 and Specimen 3 had no intentional Y addition.

The low S concentrations of Table 1 can be obtained by practice of the method of U.S. Pat. No. 5,922,148, use of low S melting charge materials, and/or from commercially available sources. Table 2 below sets forth chemistries at the top, middle, and bottom of the single crystal rods (length of 8 inches and diameter of 1.13 inches) of the CMSX-4 alloy and alloys (specimens) 1, 2, and 3 of Table 1 and showing the average values appearing as nominal alloy compositions in Table 1.

TABLE 2

| | Y | Hf | S | Ti | Al | Cr | Co | Mo | Ni | Re | Ta | W |
|---|---|---|---|---|---|---|---|---|---|---|---|---|
| Material | (ppm) | (ppm) | (ppm) | (% Wt.) | (% Wt.) | (% Wt.) | (% Wt.) | (% Wt.) | (% Wt.) | (% Wt.) | (% Wt.) | (% Wt.) |
| CMSX-4 Top | 2 | 900 | 2 | 1.0 | 5.62 | 6.3 | 9.5 | 0.6 | Bal. | 2.9 | 6.4 | 6.5 |
| Middle | 1 | 900 | 2 | 1.0 | 5.66 | 6.3 | 9.5 | 0.6 | Bal. | 2.9 | 6.4 | 6.5 |
| Bottom | 2 | 900 | 2 | 1.0 | 5.60 | 6.3 | 9.6 | 0.6 | Bal. | 2.9 | 6.4 | 6.5 |
| Average | 1.7 | 900 | 2.0 | 1.0 | 5.6 | 6.3 | 9.5 | 0.6 | Bal. | 2.9 | 6.4 | 6.5 |
| Alloy 2 Top | 9 | 4800 | 1 | 1.0 | 5.45 | 6.3 | 9.6 | 0.6 | Bal. | 3.0 | 6.3 | 6.5 |
| Middle | 64 | 5000 | 1 | 1.0 | 5.54 | 6.3 | 9.6 | 0.6 | Bal. | 3.0 | 6.4 | 6.5 |
| Bottom | 111 | 5000 | 1 | 1.0 | 5.53 | 6.3 | 9.6 | 0.6 | Bal. | 3.0 | 6.4 | 6.4 |
| Average | 61.3 | 4933 | 1.0 | 1.0 | 5.5 | 6.3 | 9.6 | 0.6 | Bal. | 3.0 | 6.4 | 6.5 |
| Alloy 1 Top | 14 | 3200 | 1 | 1.0 | 5.70 | 6.3 | 9.5 | 0.5 | Bal. | 2.9 | 6.4 | 6.5 |
| Middle | 59 | 3400 | 1 | 1.0 | 5.66 | 6.3 | 9.4 | 0.6 | Bal. | 2.9 | 6.4 | 6.4 |
| Bottom | 108 | 3400 | 2 | 1.0 | 5.72 | 6.3 | 9.5 | 0.6 | Bal. | 2.9 | 6.5 | 6.4 |
| Average | 60.3 | 3333 | 1.3 | 1.0 | 5.7 | 6.3 | 9.5 | 0.6 | Bal. | 2.9 | 6.4 | 6.4 |
| Alloy 3 Top | 6 | 5800 | 2 | 1.0 | 5.78 | 6.3 | 9.6 | 0.5 | Bal. | 2.9 | 6.4 | 6.4 |
| Middle | 1 | 6100 | 2 | 1.0 | 5.80 | 6.2 | 9.5 | 0.5 | Bal. | 2.9 | 6.4 | 6.4 |
| Bottom | 1 | 5900 | 2 | 1.0 | 5.78 | 6.3 | 9.6 | 0.5 | Bal. | 2.9 | 6.4 | 6.5 |
| Average | 1.0 | 5933 | 2.0 | 1.0 | 5.8 | 6.3 | 9.6 | 0.5 | Bal. | 2.9 | 6.4 | 6.4 |

CMSX-4 and Alloy 3 had no intentional Y addition.

The comparison test alloy specimen CMSX-4 and the test alloy specimens 1, 2, and 3 each was made as a single crystal rod which was solution heat treated, hot isostatically pressed, and machined to provide a respective 1 inch diameter single crystal rod. The rod was EDM sliced into disk shaped test coupons of 0.125 inch thickness which were ground, hand grit paper polished (600 grit paper) on the end faces, and media bowl polished before testing.

FIG. 1 illustrates that the nickel base superalloy test alloys 1 and 2 pursuant to the invention exhibited significantly lower weight loss at 2400 cycles than the CMSX-4 baseline test specimens and alloy 3 test specimens did at only 800 cycles. The nickel base superalloy test alloys 1 and 2 pursuant to the invention exhibited a mass loss per area per cycle of 0.002 and 0.010 mg/cm²-cycle, respectively. In contrast, the baseline CMSX-4 alloy had a mass loss rate of 0.167 mg/cm²-cycle. Alloy 3 without Y had a mass loss rate of 0.064 mg/cm²-cycle. It is apparent that the addition to the alloy compositions of the combination of Hf and Y in the amounts shown (alloys 1 and 2) was effective to increase cyclic oxidation resistance of the specimens by well over a factor of 10. When a gas turbine engine blade is made of a superalloy pursuant to the invention, such improved alloy oxidation resistance will help retain turbine blade tip dimensions when a protective tip coating is removed by rubbing against the tip seal.

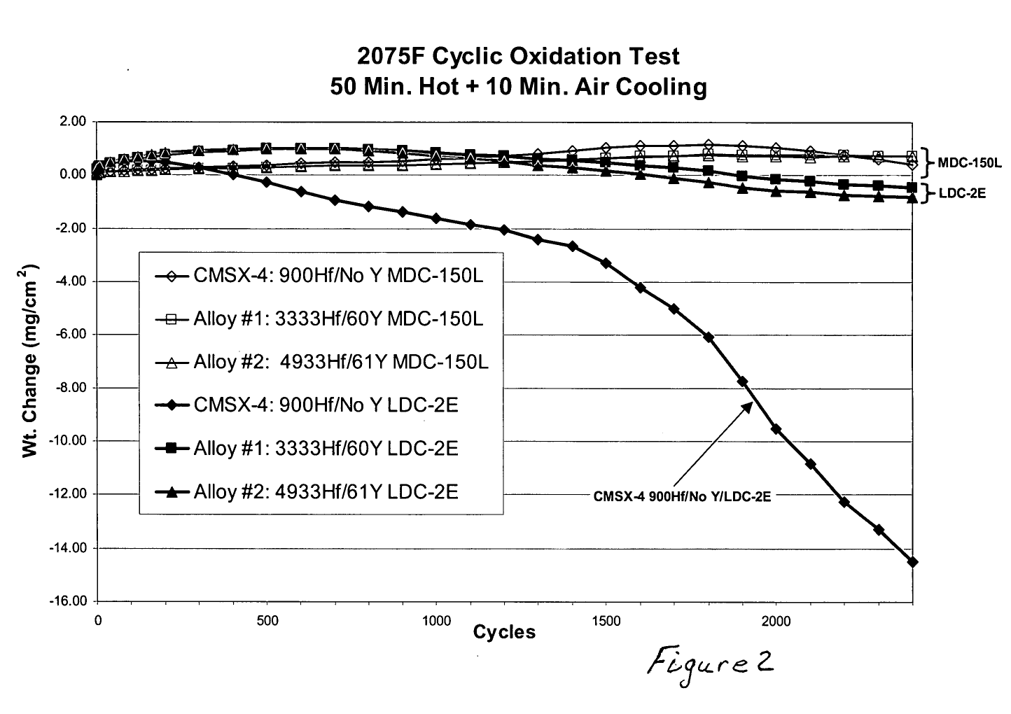

FIG. 2 is a graph of weight change versus number of cycles for the cyclic oxidation test specimens listed in the figure having the outwardly grown, single phase Pt-modified diffusion aluminide MDC-150L bondcoat on some specimens and the inwardly grown, multi-phase Pt-modified diffusion aluminide LDC-2E bondcoat on other specimens. The MDC-150L bondcoat was formed on the substrates as described in U.S. Pat. Nos. 5,261,963 and 5,264,245, the teachings of which are incorporated herein by reference. The LDC-2E bondcoat was formed on the substrates as described in U.S. Pat. No. 3 677 789, the teachings of which are incorporated herein by reference.

FIG. 2 reveals that the LDC-2E bondcoated test specimens including the combination of Hf and Y in the substrate alloy pursuant to the invention exhibited significantly increased cyclic oxidation resistance as compared to that of the CMSX-4 baseline test specimens having the same bondcoat thereon. FIG. 2 also reveals that the MDC-150L bondcoated specimens including the combination of Hf and Y in the substrate alloy pursuant to the invention exhibited cyclic oxidation resistance comparable to the already good cyclic oxidation resistance exhibited by the CMSX-4 baseline test specimens having the same bondcoat thereon. Closer inspection of the data curves and weight loss slopes reveals that the LDC-2E coated baseline CMSX-4 alloy has started to lose weight faster than the coated test alloys 1 and 2 having the Hf and Y additions. The coating life of the LDC-2E coated baseline CMSX-4 alloy will be shorter than that of the LDC-2E coated test alloys 1 and 2 if the test is continued.

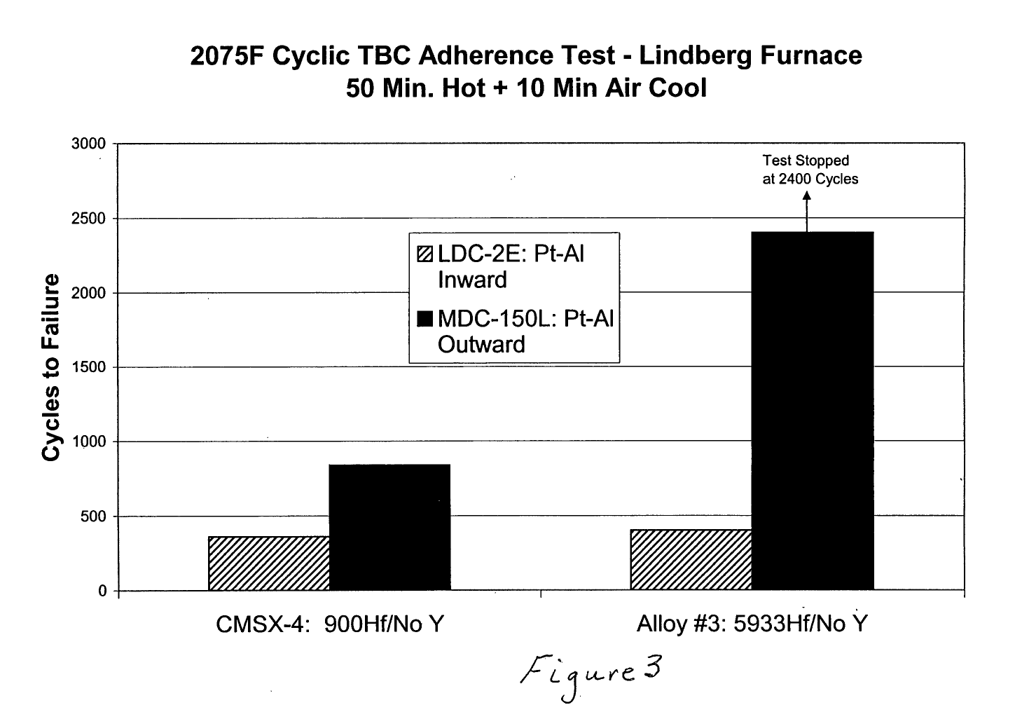

FIG. 3 is a bar graph showing TBC (thermal barrier coating) adherence on CMSX-4 and alloy 3 substrates having the outwardly grown, single phase Pt-modified diffusion aluminide MDC-150L bondcoat on some test specimens and the inwardly grown, multi-phase Pt-modified diffusion aluminide LDC-2E bondcoat on other test specimens in the above described Lindberg test. Alloy 3 had a nominal composition shown in Table 1 (as specimen 3) where Hf was present in an amount of 5933 ppm by weight. The CMSX-4 and alloy 3 test specimens having the MDC-150L bondcoat were coated with a thermal barrier coating (TBC) and tested for TBC adherence in cyclic oxidation test at 2075 degrees F. using heating/cooling cycles as described above (Lindberg test). The CMSX-4 and alloy 3 test specimens having the LDC-2E bondcoat were coated with the same TBC and were similarly tested for TBC adherence. The thermal barrier coating applied to the CMSX-4 and alloy 3 test specimens comprised 7 weight % yttria stabilized zirconia and was applied to the bondcoat of these specimens as described in U.S. Pat. No. 5,716,720, the teachings of which is incorporated herein by reference. The TBC thickness was in the range of 0.004 to 0.006 inch. A test specimen was considered failed in the cyclic oxidation testing when the thermal barrier coating was 20% spalled off on a surface area basis.

FIG. 3 reveals that increasing Hf to about 5933 ppm Hf to the test specimen substrate alloy (alloy 3) significantly improved TBC adherence for the specimens having the MDC-150L bondcoat thereon as compared to the CMSX-4 substrates (900 ppm Hf/no Y) having the same bondcoat and TBC thereon. The addition of 5933 ppm Hf to the test specimen substrate (alloy 3) having the LDC-2E bondcoat did not improve TBC adherence as compared to the CMSX-4 substrates (900 ppm Hf/no Y) having the same bondcoat and TBC thereon.

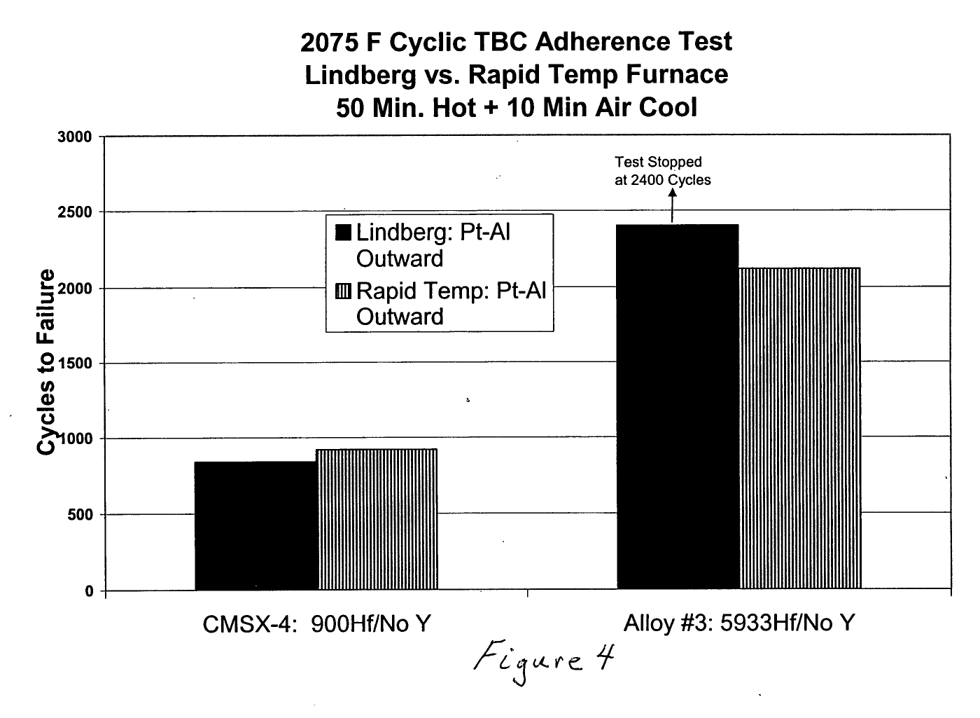

FIG. 4 is a bar graph showing cyclic oxidation TBC adherence on substrates (alloy 3) having the outwardly grown, single phase Pt-modified diffusion aluminide MDC-150L bondcoat in the above described Lindberg test and in a test using a RAPID TEMP furnace (available from CM Inc., Bloomfield, N.J.) that involves performing the same thermal cycle as the Lindberg furnace test, except that the furnace bottom drops from the hot zone with the test coupons (specimens) and a fan cools the test coupons during the cooling portion of the cycle. A specimen was considered failed in either cyclic oxidation test when the thermal barrier coating was 20% spalled off on a surface area basis.

Specimens of alloy 3 having the MDC-150L bondcoat applied as described above were coated with the thermal barrier coating (TBC) of the type used in FIG. 3.

FIG. 4 reveals that the addition of 5933 ppm Hf without Y to the specimen substrate alloy (alloy 3) significantly improved TBC adherence for the specimens having the MDC-150L bondcoat in both the Lindberg and rapid temperature furnace tests as compared to the CMSX-4 test specimens having the same bondcoat and TBC thereon. These results demonstrate the effect of Hf in two different thermal cycle test apparatus.

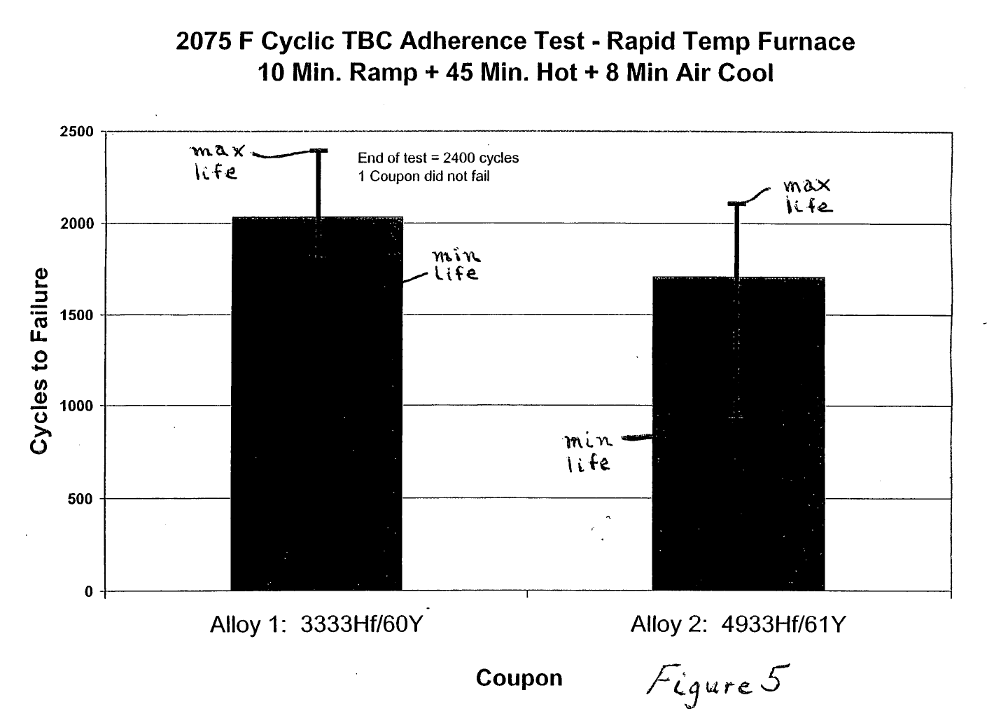

FIG. 5 represents testing in the RAPID TEMP furnace of alloys 1 and 2 having a MDC-150L bondcoat and a 7 weight % yttria stabilized zirconia TBC on the bondcoat to demonstrate the Hf effect, at lower Hf levels than FIG. 4, with a 60-61 ppm by weight Y addition to the alloy composition. Each test cycle involved placing the test specimens in the furnace for 45 minutes and then removing them from the furnace to cool in air for 8 minutes. Nine and ten coupons were tested for alloy 1 and alloy 2, respectively, where a specimen was considered failed when the thermal barrier coating was 20% spalled off on a surface area basis. At the end of the test (2400 cycles), one coupon of alloy 1 was not failed. In FIG. 5, the brackets signify the first specimen to fail (minimum life) and last specimen to fail (maximum life), and the solid bar represents the average life to failure of the specimens.

It is apparent that nickel base superalloys pursuant to the invention possess improved high temperature oxidation resistance. A nickel base superalloy substrate with Hf and with or without Y as substrate alloying elements can be coated with an outwardly grown, single phase Pt-modified diffusion aluminide bondcoat (e.g. MDC-150L bondcoat) or an inwardly grown, multi-phase Pt-modified diffusion aluminide bondcoat (LDC-2E bondcoat) followed by deposition of a ceramic thermal barrier coating (TBC) on the bondcoat to provide a TBC coated substrate pursuant to the invention. Spallation of the TBC is significantly prolonged when the substrate comprises a superalloy with Hf and with or without Y as substrate alloying elements and when the bondcoat comprises an outwardly grown diffusion aluminide bondcoat.

Although the invention has been shown and described with respect to detailed embodiments thereof, it will be understood by those skilled in the art that various changes in form and detail thereof may be made without departing from the spirit and scope of the claimed invention.

I claim:

1. Nickel base superalloy consisting essentially of, in weight %, about 3% to about 12% Cr, up to about 15% Co, up to about 3% Mo, about 3% to about 10% W, up to about 6% Re, about 5% to about 7% Al, up to about 2% Ti, up to about 1% Fe, up to about 2% Nb, about 3% to about 12% Ta, up to about 0.07% C, about 0.030% to about 0.80% Hf, up to about 0.10% Zr, up to about 0.02% B, up to about 0.050% of a rare earth element, and balance Ni and incidental impurities.

2. The superalloy of claim 1 wherein the rare earth element is selected from the group consisting of Y and Lanthanide series elements with atomic numbers from 58 to 71.

3. The superalloy of claim 2 wherein about 0.0005% to about 0.050 weight % of said rare earth element is present.

4. The superalloy of claim 1 having a sulfur concentration of 2 ppm by weight or less.

5. A coated article, comprising a nickel base superalloy substrate consisting essentially of, in weight %, about 3% to about 12% Cr, up to about 15% Co, up to about 3% Mo, about 3% to about 10% W, up to about 6% Re, about 5% to about 7% Al, up to about 2% Ti, up to about 1% Fe, up to about 2% Nb, about 3% to about 12% Ta, up to about 0.07% C, about 0.030% to about 0.80% Hf, up to about 0.10% Zr, up to about 0.02% B, up to about 0.050% of a rare earth element, and balance Ni and incidental impurities, and a bondcoat on the substrate.

6. The article of claim 5 wherein the rare earth element is selected from the group consisting of Y and Lanthanide series elements with atomic numbers from 58 to 71.

7. The article of claim 6 wherein about 0.0005% to about 0.050 weight % of said rare earth element is present.

8. The article of claim 5 having a sulfur concentration of 2 ppm by weight or less.

9. The article of claim 5 wherein the bondcoat comprises an outwardly grown diffusion aluminide coating.

10. The article of claim 5 wherein the bondcoat comprises an inwardly grown diffusion aluminide coating.

11. A coated article, comprising a nickel base superalloy substrate consisting essentially of, in weight %, about 3% to about 12% Cr, up to about 15% Co, up to about 3% Mo, about 3% to about 10% W, up to about 6% Re, about 5% to about 7% Al, up to about 2% Ti, up to about 1% Fe, up to about 2% Nb, about 3% to about 12% Ta, up to about 0.07% C, about 0.030% to about 0.80% Hf, up to about 0.10% Zr, up to about 0.02% B, up to about 0.050% of a rare earth element, and balance Ni and incidental impurities, a bondcoat on the substrate, and a ceramic thermal barrier coating on the bondcoat.

12. The article of claim 11 wherein the rare earth element is selected from the group consisting of Y and Lanthanide series elements with atomic numbers from 58 to 71.

13. The article of claim 12 wherein about 0.0005% to about 0.050 weight % of said rare earth element is present.

14. The article of claim 11 having a sulfur concentration of 2 ppm by weight or less.

15. The article of claim 11 wherein the bondcoat comprises an outwardly grown diffusion aluminide coating.
